(19) United States
(12) Patent Application Publication
(10) Pub. No.: US 2008/0246739 A1
(43) Pub. Date: Oct. 9, 2008

(54) Touch Sensitive Display Device, Apparatus and Method for Driving the Same

(76) Inventors: Uk Chul Choi, Cheonan-si (KR); Cheol-Woo Park, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/926,403

(22) Filed: Oct. 29, 2007

(30) Foreign Application Priority Data
Apr. 6, 2007 (KR) 10-2007-0034306

(51) Int. Cl. G06F 3/041; G09G 3/34; G09G 5/00

(52) U.S. Cl. 345/173; 345/206; 345/84

(57) ABSTRACT

A touch sensitive display device has a driving apparatus. The driving apparatus includes at least one of a plurality of stages, and each stage includes an input section, a middle processing unit, an output voltage generator, and an output path selection unit. The input section outputs a first voltage in response to an output signal from a previous stage or a scanning start signal. The middle processing unit outputs a second voltage in response to one of the plurality of clock signals or an output signal from a next stage. The output voltage generator charges the first voltage and generates the output signal in response to the first voltage from the input section and the second voltage from the middle processing unit. The output path selecting unit selects an output path for the output signal from the output voltage generator. Accordingly, the structure of the display device can be simplified.

### CROSS-REFERENCE TO RELATED APPLICATION

This application claims priority to Korean Patent Application No. 10-2007-0034306 filed in the Korean Intellectual Property Office on Apr. 6, 2007, the entire contents of which are incorporated herein by reference.

### BACKGROUND OF THE INVENTION

(a) Technical Field

The present invention relates to a display device, and more particularly, to a touch sensitive display device, apparatus and method for driving the same.

(b) Discussion of the Related Art

There has been much research actively directed to developing a flat panel display device that uses an electrophoretic display (EPD) device or a liquid crystal display (LCD) device.

The electrophoretic display device includes a pixel having a switching element connected to an electrophoretic capacitor, a display panel assembly having display signal lines, a gate driver for turning on/off the switching element of the pixel by applying a scanning signal formed of a gate-on voltage and a gate-off voltage to a gate line among the display signal lines, and a data driver for applying a data voltage to a pixel through a turned-on switching element by applying the data voltage to a data line among the display signal lines.

Among the constituent elements of the electrophoretic display device, the gate driver may be integrated on a display panel assembly through the same fabricating process as a switching element of a pixel in order to reduce fabricating cost. The integrated gate driver is a shift register including a plurality of stages.

Touch sensitive display devices have been introduced. Touch sensitive display devices may include, for example, an LCD device or an EPD device.

### SUMMARY OF THE INVENTION

Exemplary embodiments of the present invention provide an apparatus for driving a display device, a display device having the same, and a driving method thereof having a simplified structure.

Since the touch sensitive display device senses touch and displays images, the touch sensitive display device has a more complicated structure than a normal display device having a function of displaying an image.

Therefore, exemplary embodiments of the present invention simplify a structure of a touch sensitive display device, particularly a structure of an electrophoretic display.

According to an exemplary embodiment of the present invention, an apparatus for driving a display device includes a plurality of stages connected with one another for sequentially generating output signals in synchronization with a plurality of clock signals. At least one of the plurality of stages includes an input section, a middle processing unit, an output voltage generator, and an output path selecting unit. The input section outputs a first voltage in response to an output signal from a previous stage or a scanning start signal. The middle processing unit outputs a second voltage in response to one of the plurality of clock signals or an output signal from a next stage. The output voltage generator charges the first voltage and generates the output signal in response to the first voltage from the input section and the second voltage from the middle processing unit. The output path selecting unit selects an output path for the output signal from the output voltage generator.

The first voltage may be a high gate-on voltage Von, and the second voltage may be a low gate-off voltage Voff.

At least one of the plurality of stages may have a first output terminal and a second output terminal, and the output path selecting unit may output the output signal through the output path by selecting the first output terminal or the second output terminal.

The output path selecting unit may include a first transistor connected with the first output terminal, and a second transistor connected with the second output terminal.

The first transistor and the second transistor may operate opposite to each other.

First and second selection signals that are opposite in phase may be applied to respective control terminals of the first and second transistors.

At least one of the plurality of stages may further include a set terminal, a reset terminal, a gate voltage terminal, first and second clock terminals, and first and second selection terminals. The input section may include a third transistor that is connected between the set terminal and a first junction and has a control terminal connected with the set terminal. The middle processing unit may include fourth and fifth transistors connected in parallel between the first junction and the gate voltage terminal, a sixth transistor connected between a second junction and the gate voltage terminal, and a first capacitor connected between the second junction and the first clock terminal. The fourth transistor may have a control terminal connected with the reset terminal, the fifth transistor may have a control terminal connected with the second junction, and the sixth transistor may have a control terminal connected with the first junction. The output voltage generator may include a seventh transistor connected between a third contract and the first clock terminal, eighth and ninth transistors connected in parallel between the third junction and the gate voltage terminal, and a second capacitor connected between the first junction and the third junction. The seventh transistor may have a control terminal connected with the first junction, the eighth transistor may have a control terminal connected with the second junction, and the ninth transistor may have a control terminal connected with the second clock terminal. The first and second transistors may be connected with the third junction.

A first selection signal may be applied to the first selection terminal, and a second selection signal having a phase difference of 180° from the first selection signal may be applied to the second selection terminal.

At least one of the plurality of stages may further include a carry output terminal for outputting the output signal to previous and next stages.

According to an exemplary embodiment of the present invention, a display device includes a display panel assembly and a gate driver. The display panel assembly includes a plurality of pixels having first switching elements, a plurality of image scanning lines connected with the first switching elements, a plurality of sensors having second switching elements, and a plurality of sensing scanning lines connected with the second switching elements. The gate driver is connected with the image scanning lines and the sensing scanning lines. The gate driver generates output signals and selectively applies the output signals to one of the image scanning lines and the sensing scanning lines.

The gate driver may include a plurality of stages connected with one another for generating output signals in turn in synchronization with a plurality of clock signals. At least one of the plurality of stages may include an input section, a middle processing unit, an output voltage generator, and an output path selection unit. The input section may output a first voltage in response to an output signal from a previous stage or a scanning start signal. The middle processing unit may output a second voltage in response to one of the plurality of clock signals or an output signal from a next stage. The output voltage generator may charge the first voltage and generate the output signal in response to the first voltage from the input section and the second voltage from the middle processing unit. The output path selecting unit selects an output path for the output signal from the output voltage generator.

The output path selecting unit may include a first transistor connected with one of the image scanning lines, and a second transistor connected with one of the sensing scanning lines. The first transistor and the second transistor may operate opposite to each other.

First and second selection signals that are opposite in phase may be applied to respective control terminals of the first and second transistors.

At least one of the plurality of stages may further include a set terminal, a reset terminal, a gate voltage terminal, first and second clock terminals, and first and second selection terminals. The input section may include a third transistor that is connected between the set terminal and a first junction and have a control terminal connected with the set terminal. The middle processing unit may include fourth and fifth transistors connected in parallel between the first junction and the gate voltage terminal, a sixth transistor connected between a second junction and the gate voltage terminal, and a first capacitor connected between the second junction and the first clock terminal. The fourth transistor may have a control terminal connected with the reset terminal, the fifth transistor may have a control terminal connected with the second junction, and the sixth transistor may have a control terminal connected with the first junction. The output voltage generator may include a seventh transistor connected between a third contract and the first clock terminal, eighth and ninth transistors connected in parallel between the third junction and the gate voltage terminal, and a second capacitor connected between the first junction and the third junction. The seventh transistor may have a control terminal connected with the first junction, the eighth transistor may have a control terminal connected with the second junction, and the ninth transistor may have a control terminal connected with the second clock terminal.

At least one of the plurality of stages may further include a carry output terminal for outputting the output signal to previous and next stages.

The first and second switching elements and the first to ninth transistors may be made of amorphous silicon.

The gate driver may be integrated with the display panel assembly.

According to an exemplary embodiment of the present invention, a method for driving a display device including a plurality of pixels connected with image scanning lines and image data lines and a plurality of sensors connected with sensing scanning lines and sensing data lines includes applying a gate-on voltage to the image scanning lines in response to a first selection signal, displaying an image through the pixels by applying an image data voltage to the image data lines, applying a gate-on voltage to the sensing scanning lines in response to a second selection signal, and performing a sensing operation by processing sensing data signals from the sensing data lines.

The applying of the gate-on voltage to the image scanning lines and the displaying of the image may alternate with the applying the gate-on voltage to the sensing scanning lines and the performing of the sensing operation.

After the applying of the gate-on voltage to the image scanning lines and the displaying of the image are performed for the pixels, the applying of the gate-on voltage to the sensing scanning lines and the performing of the sensing operation may be performed for the sensors.

After the applying of the gate-on voltage to the image scanning lines and the displaying of the image are performed for the pixels more than twice successively, the applying of the gate-on voltage to the sensing scanning lines and the performing of the sensing operation may be performed for the sensors.

### BRIEF DESCRIPTION OF THE DRAWINGS

These and/or other aspects and features of the exemplary embodiments of the present invention will become apparent and more readily appreciated from the following description of the exemplary embodiments, taken in conjunction with the accompanying drawings of which:

FIG. 1 is a block diagram illustrating an electrophoretic display device according to an exemplary embodiment of the present invention;

FIG. 2 is an equivalent circuit diagram of a pixel and a sensor in an electrophoretic display device according to an exemplary embodiment of the present invention;

FIG. 3 is a cross-sectional view of a display panel assembly of an electrophoretic display according to an exemplary embodiment of the present invention;

FIG. 4 is a block diagram illustrating a gate driver according to an exemplary embodiment of the present invention;

FIG. 5 is a circuit diagram of an i-th stage circuit of a shift register for a gate driver shown in FIG. 4; and

FIG. 6 is a timing diagram illustrating signal waveforms for describing the operation of a gate driver shown in FIG. 4.

### DETAILED DESCRIPTION OF EXEMPLARY EMBODIMENTS

Hereinafter, exemplary embodiments of the present invention will be described more fully with reference to the accompanying drawings.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

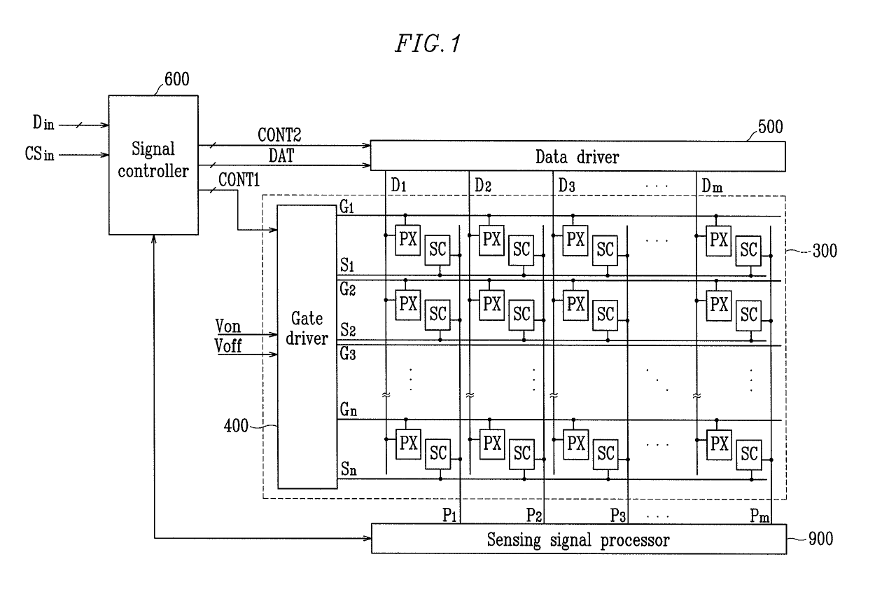

First, an electrophoretic display will be described with reference to FIG. 1 to FIG. 3 as an example of a display device according to an exemplary embodiment of the present invention.

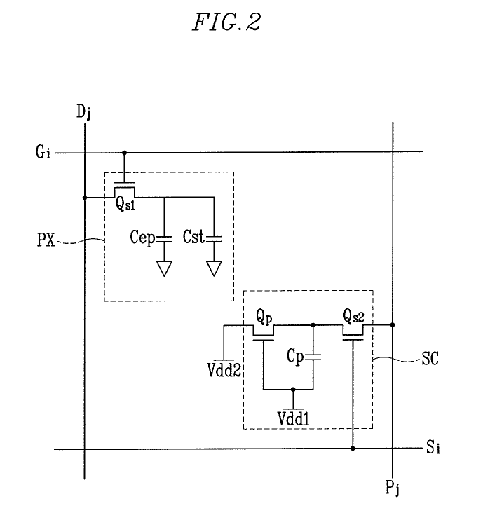

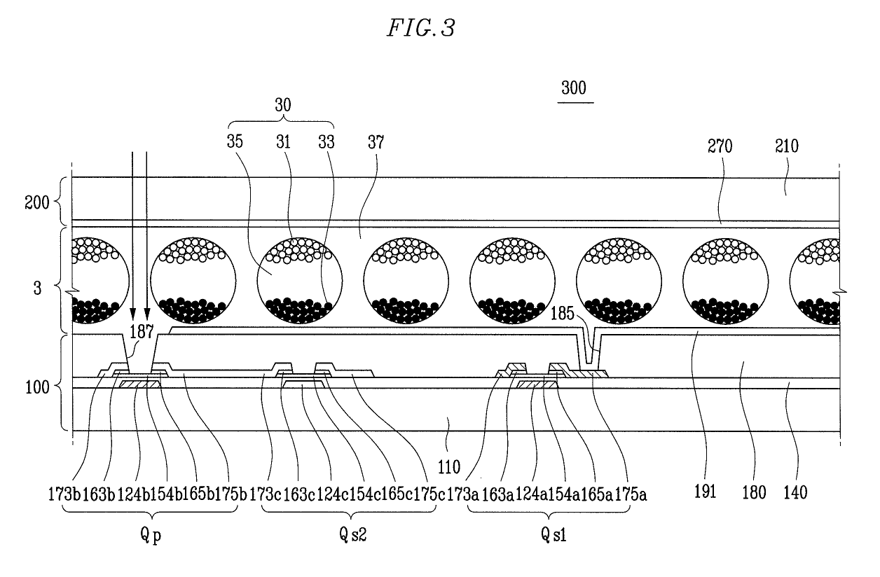

FIG. 1 is a block diagram illustrating an electrophoretic display device according to an exemplary embodiment of the present invention. FIG. 2 is an equivalent circuit diagram of a pixel and a sensor in an electrophoretic display device according to an exemplary embodiment of the present invention. FIG. 3 is a cross-sectional view of a display panel assembly of an electrophoretic display according to an exemplary embodiment of the present invention.

As shown in FIG. 1, the electrophoretic display according to an exemplary embodiment includes an electrophoretic panel assembly 300, a gate driver 400, a data driver 500, a sensing signal processor 900, and a signal controller 600.

As shown in the equivalent circuit of FIG. 1 and FIG. 2, the electrophoretic display panel assembly 300 includes a plurality of display signal lines G1 to Gn and D1 to Dm, a plurality of sensing signal lines S1 to Sn and P1 to Pm, and a plurality of pixels PX and a plurality of sensors SC, which are arranged basically in a matrix. Further, as shown in FIG. 3, the electrophoretic display panel assembly 300 includes respective lower and upper panels 100 and 200 facing each other and an electrophoretic layer 3 interposed between the lower and upper panels 100 and 200. The upper panel 200 includes an insulation substrate 210 made of transparent glass or plastic.

The display signal lines G1 to Gn and D1 to Dm are formed on an insulation substrate 110 made of a transparent glass or plastic of the lower panel 100, and include a plurality of image scanning lines G1 to Gn for transferring an image scanning signal and a plurality of image data lines D1 to Dm for transferring an image data signal. The image scanning lines G1 to Gn extend basically in a row direction to run almost parallel to each other, and the image data lines D1 to Dm extend basically in a column direction to run almost parallel to each other.

The sensing signal lines S1 to Sn and P1 to Pm are also formed on the insulation substrate 110, and include a plurality of sensing scanning lines S1 to Sn for transmitting a scanning signal and a plurality of data lines P1 to Pm for transmitting a sensing data signal. The sensing scanning lines S1 to Sn extend basically in a row direction to run almost parallel to each other, and the sensing data lines P1 to Pm extend basically in a column direction to run almost parallel to each other.

As shown in FIG. 2 and FIG. 3, each pixel PX, for example a pixel PX connected to an i^{th} image scanning line Gi and a j^{th} image data line Dj, includes a switching element Qs1 connected to the display signal lines Gi and Dj, and an electrophoretic capacitor Cep and a storage capacitor Cst that are connected to the switching element Qs1, where i=1, 2, . . . , n and j=1, 2 . . . , m.

The switching element Qs1 is a three terminal element such as a thin film transistor disposed on the lower panel 100. The switching element Qs1 includes a control terminal 124a connected to an image scanning line Gi, an input terminal 173a connected to an image data line Dj, and an output terminal 175a connected to an electrophoretic capacitor Cep and a storage capacitor Cst. Also, the switching element QS1 includes a semiconductor 154a formed between the control terminal 124a and the input terminal 173a and between the control terminal 124a and the output terminal 175a, and ohmic contacts 163a and 165a formed on the semiconductor 154a.

The electrophoretic capacitor Cep includes a pixel electrode 191 of the lower panel 100 and a common electrode 270 are formed on an insulation substrate 110 made of a transparent glass or plastic of the upper panel 200 as two terminals, and an electrophoretic layer 3 between the two electrodes 191 and 270 operates as a dielectric material.

The pixel electrode 191 is connected to a switching element Qs1, and the common electrode 270 is formed on the entire surface of the upper panel 200 and receives a common voltage Vcom. The pixel electrode 191 is made of a transparent conductor or an opaque metal such as ITO or IZO, and the common electrode 270 is made of a transparent conductor. A passivation layer 180 is interposed between the pixel electrode 191 and the switching element Qs1. The pixel electrode 191 is connected to the output terminal 175a of the switching element Qs1 through a contact hole 185 of the passivation layer 180.

The electrophoretic layer 3 includes a plurality of microcapsules 30 and a binder 37 for fixing the microcapsules 30. Each of the microcapsules 30 includes a white electrophoretic particle 31 charged with a negative charge (−) or a positive charge (+), a black electrophoretic particle 33 charged with the opposite charge, and a transparent dielectric fluid 35.

A storage capacitor Cst functioning as an under part of the electrophoretic capacitor Cep is formed of an additional signal line (not shown) formed on the lower display panel 100 overlapping with the pixel electrode 191 with an insulating material interposed therebetween. A predetermined voltage such as a common voltage Vcom is applied to the additional signal line. However, the storage capacitor Cst may be formed of the pixel electrode 191 overlapping with a previous image scanning line Gi-1 with an insulator as a medium. The storage capacitor Cst may be omitted according to need.

Each of the sensors SC, for example a sensor SC connected to an i^{th} sensing scanning line Si and a j^{th} sensing data line Pj, includes a sensing element Qp, a switching element Qs2, and a sensing capacitor Cp, where i=1, 2, . . . , n and j=1, 2, . . . , m. The sensor SC is formed on the lower panel 100 and is mostly covered by the passivation layer 180.

The sensing element Qp is a three terminal element such as a thin film transistor. The sensing element Qp includes a control terminal 124b connected to a sensing control voltage Vdd1, an output terminal 175b connected to one end of a capacitor Cp and an input terminal 173c of a switching element Qs2, and an input terminal 173b connected to a sensing input voltage Vdd2. The sensing element Qp includes a semiconductor 154b formed between a control terminal 124b and an input terminal 173b and between a control terminal 124b and an output terminal 175b, and ohmic contacts 163b and 165b formed on the semiconductor 154b. When light is radiated to the semiconductor 154b of the sensing element Qp through an exposure hole 187 formed on the passivation layer 180, an optical current is formed. The optical current flows to the sensing capacitor Cp and the switching element Qs2 by a voltage difference between an input terminal 173b and an output terminal 175b.

The sensing capacitor Cp includes one end connected to a sensing control voltage Vdd1 and the other end connected to an output terminal 175b of a sensing element Qp and an input terminal 173c of a switching element Qs2. The sensing capacitor Cp accumulates a charge according to an optical current from the sensing element Qp to sustain a predetermined voltage.

Also, the switching element Qs2 is a three terminal element such as a thin film transistor. The switching element Qs2 includes a control terminal 124c connected to a sensing scanning line Si, an output terminal 175c connected to a sensing data line Pj, and an input terminal 173c connected to an output terminal of a sensing element Qp. The switching element Qs2 includes a semiconductor 154c formed between a control terminal 124c and an input terminal 173c and between a control terminal 124c and an output terminal 175c, and ohmic contacts 163c and 165c formed on the semiconductor 154c. The switching element Qs2 outputs a voltage stored in a sensing capacitor Cp or an optical current from a sensing element Qp to a sensing data line Pj as a sensing data signal when a sensing scanning signal is applied.

The switching elements Qs1 and Qs2 and the semiconductors 154a, 154c, and 154b of the sensing element Qp may be formed of an amorphous silicon or polysilicon thin film transistor. The switching elements Qs1 and Qs2, the control terminals 124a, 124b, and 124c of the sensing element Qp, and the semiconductors 154a, 154b, and 154c are insulated from each others by a gate insulating layer 140 made of silicon nitride (SiNx).

Although the pixels PX and the sensors SC were described to be identical in number, the number of sensors SC may be smaller than the number of pixels PX. Accordingly, the number of sensing scanning lines S1 to Sn and sensing data lines P1 to Pm may be controlled.

For example, if a resolution of a liquid crystal display is a quarter video graphic array (QVGA, 240*320 dots) and a resolution of a sensor SC is QVGA, one sensor SC is disposed per three pixels PX. If a resolution of a sensor SC is QQVGA (quarter QVGA, 120*160 dots), one sensor Sc is disposed per 12 pixels PX. Herein, 1 dot denotes a unit having three pixels PX for displaying one image.

The gate driver 400 is connected to image scanning lines G1 to Gn for applying an image scanning signal to the image scanning lines G1 to Gn. The gate driver 400 is also connected to sensing scanning lines S1 to Sn for applying a sensing scanning signal to the sensing scanning lines S1 to Sn. The image scanning signal and the sensing scanning signal include voltages for turning switching elements QS1 and Qs2 on or off. The gate driver 400 may be integrated on an electrophoretic display panel assembly 300 with signal lines G1 to Gn, D1 to Dm, S1 to Sn, and P1 to Pm, switching elements Qs1 and Qs2, and sensors SC. However, the gate driver 400 may be directly disposed on the electrophoretic display panel assembly 300 as a form of at least one IC chip, may be attached on the electrophoretic display panel assembly 300 as a form of a tape carrier package TCP after being mounted on a flexible printed circuit film (not shown), or may be mounted on an additional printed circuit board PCB (not shown).

The data driver 500 is connected to image data lines D1 to Dm of an electrophoretic display panel assembly 300 and applies an image data signal to the data lines D1 to Dm.

A sensing signal processor 900 is connected to sensing data lines P1 to Pm of an electrophoretic display panel assembly 300 and receives a sensing data signal outputted through sensing data lines P1 to Pm.

Each of the data driver 500 and the sensing signal processor 900 may be directly disposed on the electrophoretic display panel assembly 300 as a form of at least one IC chip, may be attached on the electrophoretic display panel assembly 300 as a form of a tape carrier package TCP after being mounted on a flexible printed circuit film (not shown), or may be mounted on an additional printed circuit board PCB (not shown). Although unlikely, the data driver 500 and the sensing signal processor 900 may be integrated on an electrophoretic display panel assembly 300 with signal lines G1 to Gn, D1 to Dm, S1 to Sn, and P1 to Pm, switching elements Qs1 and Qs2, and sensors SC.

The signal controller 600 controls the operations of the gate driver 400, the data driver 500, and the sensing signal processor 900.

Meanwhile, the electrophoretic display device further includes a gray voltage generator for generating a gray voltage and providing the generated gray voltage to the data driver 500. In this case, the data driver 500 applies gray voltages or divided gray voltages to the image data lines D1 to Dm as an image data signal.

Hereinafter, the image display operation and the optical sensing operation of an electrophoretic display device will be described in detail.

The signal controller 600 receives an input image signal Din from an external graphics controller (not shown) and an input control signal CSin for controlling the display of the input image signal. For example, the input control signal includes a vertical synchronization signal, a horizontal synchronizing signal, a main clock signal, and a data enable signal.

The signal controller 600 appropriately processes the input image signal Din according to an operating condition of an electrophoretic display panel assembly 300 based on the input image signal Din and the input control signal CSin, generates a gate control signal CONT1 and a data control signal CONT2, transmits the gate control signal CONT1 to the gate driver 400, and transmits the data control signal CONT2 and the processed output image signal DAT to the data driver 500.

The gate control signal CONT1 includes a scanning start signal STV for instructing to start scanning of a scanning signal, at least one of clock signals CLK for controlling the output of the scanning signal, and a selection signal SEL for selecting and scanning one of the image scanning lines G1 to Gn and the sensing scanning lines S1 to Sn. The gate control signal CONT1 further includes an output enable signal OE for limiting a duration of a gate-on voltage Von.

The data control signal CONT2 includes a horizontal synchronization start signal STH for informing the data transmission of one pixel row, a load signal LOAD for applying a corresponding data voltage to image data lines D1 to Dm, and a data clock signal HCLK.

The data driver 500 receives an output image signal DAT for a row of pixels PX according to the data control signal CONT2 from the signal controller 600, converts the output image signal DAT to a corresponding data voltage, and applies the converted voltage to the data lines D1 to Dm.

The gate driver 400 turns on a switching element Qs1 connected to image scanning lines G1 to Gn by applying a scanning signal to the image scanning lines G1 to Gn in response to the gate control signal CONT1 from the signal controller 600. Accordingly, the data voltage applied to the data lines D1 to Dm is applied to a corresponding pixel PX through the turned-on switching element Qs1.

The difference between a data voltage applied to a pixel PX and a common voltage Vcom is shown as a charging voltage of an electrophoretic capacitor Cep, for example, a pixel voltage. The locations of the electrophoretic particles 31 and 33 vary in the microcapsule 30 according to a pixel voltage level, a polarity of a pixel voltage, and a time of applying a pixel voltage.

For example, if a white electrophoretic particle 31 is located closer to a common electrode 270, the electrophoretic display device displays a white color. On the contrary, if a black electrophoretic particle 33 is located closer to a common electrode 270, the electrophoretic display device displays a black color. If white and black color electrophoretic particles 31 and 33 are located in the middle of a microcapsule 30, the electrophoretic display device displays a gray color. As described above, the electrophoretic display device displays various gray images by changing the locations of the electrophoretic particles 31 and 33 in a microcapsule 30.

When a predetermined period (one period of a horizontal synchronizing signal Hsync, and a data enable signal DE) passes, the data driver 500 and the gate driver 400 repeatedly perform the same operation for the next row of pixels. As described above, a gate-on voltage Von is sequentially applied to the image scanning lines G1 to Gn, thereby applying a data voltage to the pixels PX.

Then, the gate driver 400 sequentially applies a gate-on voltage Von to sensing scanning lines S1 to Sn in response to a gate control signal CONT1 from the signal controller 600. Accordingly, the sensing data lines P1 to Pm transfer the sensing data signal from the sensor SC to the sensing signal processor 900. The sensing signal processor 900 amplifies or filters a sensing data signal, converts the amplified or filtered sensing data signal to a digital signal, and transmits the digital signal to the signal controller 600. The signal controller 600 transmits various controls signals CONT1 and CONT2 and an output image signal DAT to the gate driver 400 and the data driver 500 in order to display a predetermined image according to information included in the digital signal.

The sensing input voltage Vdd2 may be identical to a gate-off voltage Voff.

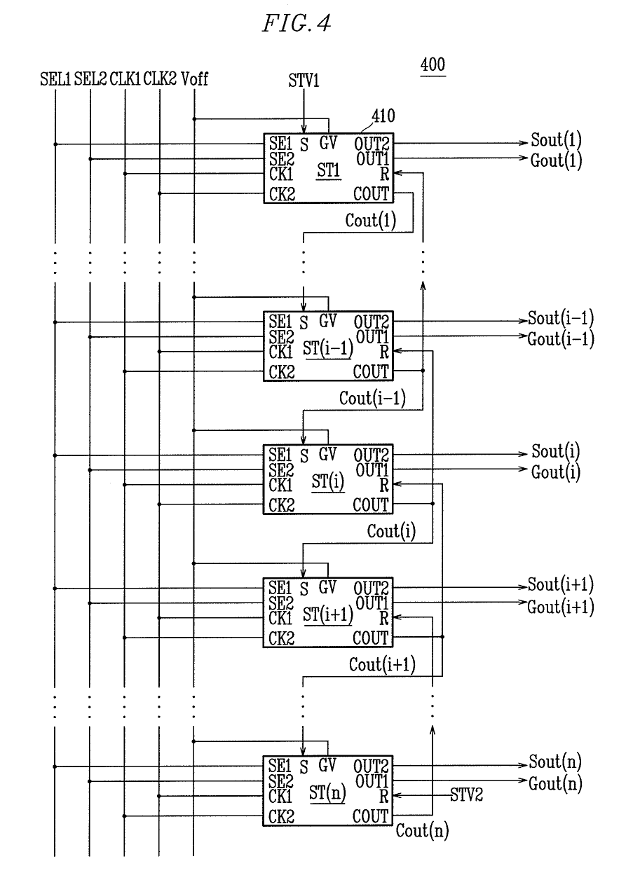

Hereinafter, an apparatus for driving a display device according to an exemplary embodiment of the present invention will be described with reference to FIG. 4 to FIG. 6. 4

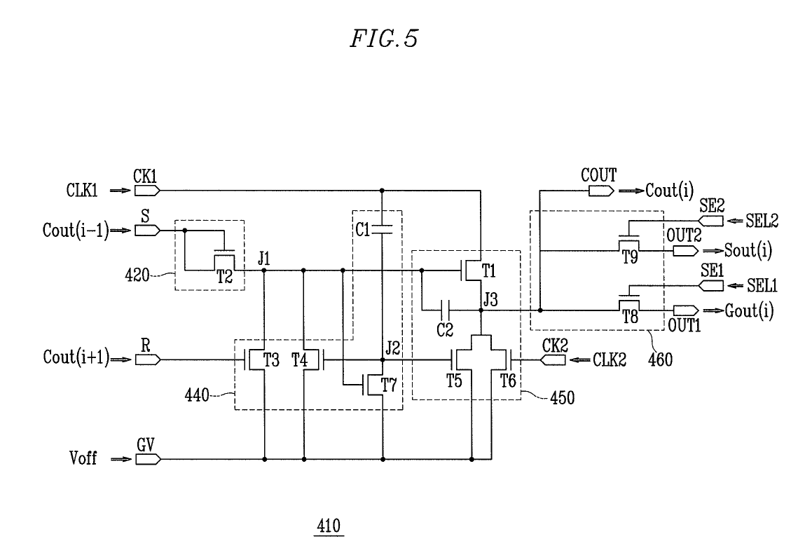

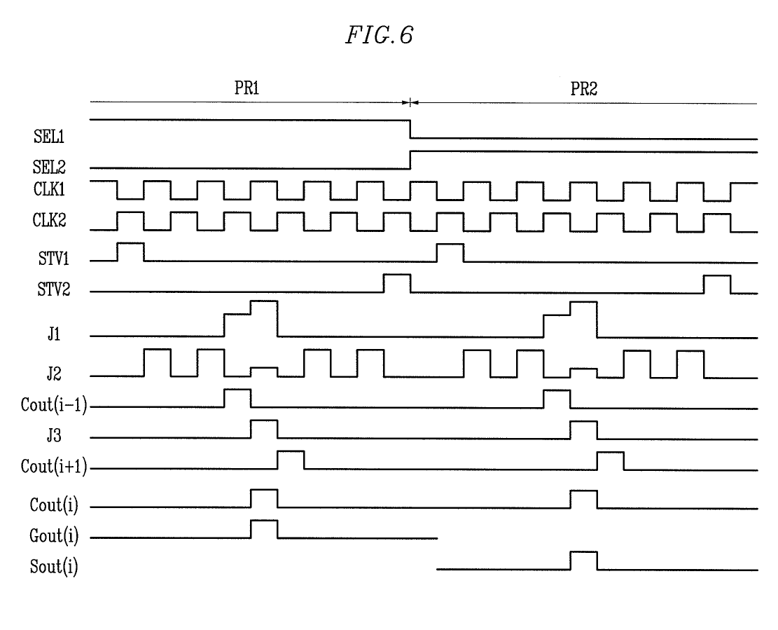

FIG. 4 is a block diagram illustrating a gate driver according to an exemplary embodiment of the present invention. FIG. 5 is a circuit diagram of an i^{th} stage of a shift register for the gate driver shown in FIG. 4. FIG. 6 is a timing diagram illustrating signal waveforms for describing the operation of the gate driver shown in FIG. 4.

As shown in FIG. 4, a gate driver 400 is a shift register including a plurality of stages 410 each having respective sides connected to image scanning lines G1 to Gn and sensing scanning lines S1 to Sn. The gate driver 400 receives scanning start signals STV1 and STV2, clock signals CLK1 and CLK2, path selection signals SEL1 and SEL2, and a gate-off voltage Voff.

Each of the stages 410 includes a set terminal S, a reset terminal R, a gate voltage terminal GV, output terminals OUT1 and OUT2, clock terminals CK1 and CK2, selection terminals SE1 and SE2, and a carry output terminal COUT.

In each of the stages 410, for example an i^{th} stage [ST(i)], the set terminal S receives a carry signal [Cout(i−1)] of a previous stage [ST(i−1)], the reset terminal R receives a carry signal [Cout(i−1)] of the next stage [ST(i+1)], and the clock terminals CK1 and CK2 receive clock signals CLK1 and CLK2. The output terminal OUT1 outputs an image scanning output [Gout(i)] to an image scanning line Gi, and the output terminal OUT2 outputs a sensing scanning output [Sout(i)] to a sensing scanning line S1.

Also, the selection terminals SE1 and SE2 receive path selection signals SEL1 and SEL2. The carry output terminal COUT outputs a carry signal [Cout(i)] to a previous stage [ST(i−1)] and the next stage [ST(i+1)]. Herein, the carry signal may be identical to the image scanning output [Gout(i)] or the sensing scanning output [Sout(i)].

In other words, each of the stages 410 generates one of an image scanning output [Gout(i)] and a sensing scanning output [Sout(i)], and a carry signal [Cout(i)] based on a carry signal [Cout(i−1)] of a pervious stage [ST(i−1)] and a carry signal [Cout(i+1)] of the next stage [ST(i+1)], in synchronization with clock signals CLK1 and CLK2. Then, one of the scanning output [Gout(i)] and the sensing scanning output [Sout(i)] is determined according to path selection signals SEL1 and SEL2.

However, a scanning start signal STV1 is inputted to the first stage ST1 of a shift register instead of the carry signal of the previous stage, and a scanning start signal STV2 is inputted to the last stage [ST(n)] instead of the carry signal of the next stage.

The clock signals CLK1 and CLK2 have a duty ratio of about 50% and a phase difference of about 180°. The path selection signals SEL1 and SEL2 also have a duty ratio of about 50% and a phase difference of about 180°.

For example, if a clock signal CLK1 is inputted to a clock terminal CK1 and a clock signal CLK2 is inputted to a clock terminal CK2 in an i^{th} stage [ST(i)], a clock signal CLK2 is inputted to a clock terminal CK1 and a clock signal CLK1 is inputted to a clock terminal CK2 in adjacent (i−1)^{th} and (i+1)^{th} stages [ST(i−1) and ST(i+1)].

Referring to FIG. 5, each of the stages of the gate driver 400 according to the present embodiment, for example an i^{th} stage, includes an input section 420, a middle processing unit 440, an output voltage generator 450, and an output path selecting unit 460. Each of the constituent elements includes at least one of N channel field effect transistors T1 to T9. Instead of the N channel field effect transistors, P channel field effect transistors can be used.

The input section 420 includes a transistor T2 connected to a set terminal S. The transistor T2 includes an input terminal and a control terminal, which are commonly connected to the set terminal S, and operates as a diode. The transistor T2 outputs a gate-on voltage Von, which is a high voltage, to a junction J1.

The middle processing unit 440 outputs a gate-off voltage Voff, which is a low voltage, to junctions J1 and J2, and includes three transistors T3, T4, and T7, and a capacitor C1.

The transistor T3 has a control terminal connected to a reset terminal R and outputs a gate-off voltage Voff to a junction J1. The transistor T4 includes a control terminal connected to a junction J2, and outputs a gate-off voltage Voff to a junction J1. The transistor T7 includes a control terminal connected to a junction J1, and outputs a gate-off voltage Voff to a junction J2.

The capacitor C1 is connected between a clock terminal CK1 and a junction J2.

The output voltage generator 450 is connected between a first clock terminal CK1 and a gate-off voltage terminal GV, selectively outputs a first clock signal CLK1 and a gate-off voltage Voff to a junction J3 according to a voltage of junctions J1 and J2, and includes three transistors T1, T5, and T6, and a capacitor C2.

The transistor T1 includes a control terminal connected to a junction J1, and outputs a clock signal CLK1 to a junction J3. The transistor T5 includes a control terminal connected to a junction J2, and outputs a gate-off voltage Voff to a junction J3. The transistor T6 includes a control terminal connected to a clock terminal CK2, and outputs a gate-off voltage Voff to a junction J3.

The capacitor C2 is connected between a junction J1 and a junction J3.

The output path selecting unit 460 includes a transistor T8 connected between an output terminal OUT1 and a junction J3, and a transistor T9 connected between an output terminal OUT2 and a junction J3.

The transistor T8 includes a control terminal connected to a selection terminal SE1, and transmits the voltage of a junction J3 to an output terminal OUT1 connected to image scanning lines G1 to Gn. The transistor T9 includes a control terminal connected to a selection terminal SE2, and transmits the voltage of a junction J3 to an output terminal OUT2 connected to sensing scanning lines S1 to Sn.

Hereinafter, the operation of the shift register shown in FIG. 5 will be described with reference to FIG. 6.

Before the operation of the shift register is described, it is required to consider that the previous stage [ST(i−1)] and the next stage [ST(i+1)] generate outputs in synchronization with a second clock signal CLK2 if an i^{th} stage [ST(i)] generates an output in consideration of a first clock signal CLK1. Also, a voltage level corresponding to a high voltage of clock signals CLK1 and CLK2 is identical to a gate-on voltage Von, and refers to a high voltage. A voltage level corresponding to a low level is identical to a gate-off voltage Voff and refers to a low voltage.

Initially, when the first clock signal CLK1 transits to the low voltage and the second clock signal CLK2 and a previous carry signal [Cout(i−1)] transit to the high voltage, transistors T2 and T6 are turned on. Then, a gate-on voltage Von is transferred to a junction J1 through the transistor T2. As a result, transistors T1 and T7 are turned on. When a gate-off voltage Voff of a gate voltage terminal GV is transferred to a junction J2 through the transistor T7, transistors T4 and T5 are turned off. Then, a transistor T3 is sustained in a turned-off state because the next carry signal [Cout(i+1)] is the low voltage. Meanwhile, a gate-off voltage Voff is transferred to a junction J3 through two turned-on transistors T1 and T6.

When a previous carry signal [Cout(i−1)] and the second clock signal CLK2 transit to the low voltage and the first clock signal CLK1 transits to a high voltage, the transistors T2 and T6 are turned off. Then, the transistor T3 is sustained in a turned-off state because a next carry signal [Cout(i+1)] is sustained at the low voltage. When the transistor T2 is turned off, the junction J1 is disconnected from the set terminal S, thereby becoming floated. Accordingly, the transistors T1 and T7 are sustained in a turned-on state. Then, the gate-off voltage Voff is applied to the junction J2 through the transistor T7. Accordingly, the transistors T4 and T5 are sustained in a turned-off state.

Since the transistors T5 and T6 are turned off, the gate-off voltage Voff of the gate voltage terminal GV transferred to the junction J3 is interrupted. Since the transistor T1 is sustained in a turned-on state, the gate-on voltage Von, which is the high voltage of the first clock signal CLK1, is transferred to the junction J3. Therefore, the junction J3 of the i^{th} stage [ST(i)] becomes identical to the gate-on voltage Von in synchronization with a rising edge of the first clock signal CLK1.

At this time, the capacitor C2 charges a voltage corresponding to the difference of the gate-on voltage Von and the gate-off voltage Voff. Meanwhile, since the capacitor C2 sustains a constant voltage, the voltage of the junction J3 rises to the gate-on voltage Von. As a result, the voltage of the floated junction J1 further rises as much as the gate-on voltage Von. Due to parasitic capacitance induced from the overlapping of the control terminal and the output terminal of the transistor T7, the voltage of the junction J1, which is the control terminal, increases. Then, the potential of the junction J2, which is the output terminal, also increases, for example, as shown.

The capacitor C1 charges a voltage corresponding to the difference of the gate-on voltage Von that is a high voltage of the first clock signal CLK1 and the gate-off voltage Voff that is the voltage of a junction J2.

When the first clock signal CLK1 transits to the low voltage and the second clock signal CLK2 and the next carry signal [Cout(i+1)] transit to the high voltage, the transistors T3 and T6 are turned on. Since the previous carry signal [Cout(i−1)] is sustained at the low voltage, the transistor T2 is sustained in a turned-off state. Since the transistor T3 is turned on, the gate-off voltage Voff is transferred to the junction J1 and the transistors T1 and T7 are turned off.

When the transistor T7 is turned off, the junction J2 becomes floated. Since the capacitor C1 then sustains a constant voltage, the first clock signal CLK1 transits to the low voltage. Accordingly, the voltage of the junction J2 further falls below the gate-off voltage Voff. However, when the voltage of the junction 2 falls below the gate-off voltage Voff, the transistor T7 is turned on again and the gate-off voltage Voff is transferred to the junction J2. Therefore, the voltage of the junction J2 becomes almost identical to the gate-off voltage Voff in a final parallel state. Accordingly, the transistors T4 and T5 are continuously sustained in a turned-off state.

Since the transistor T1 is turned off and the transistor T6 is turned on, the gate-off voltage Voff of the gate voltage terminal GV is transferred and outputted to the junction J3, and the capacitor C2 is discharged.

After that, the first and second clock signals CLK1 and CLK2 transit to the low voltage and the high voltage, respectively. However, the voltage level variation of the first clock signal CLK1 lifts the voltage of the junction J2 up to the gate-off voltage Voff, and the voltage level variation of the second clock signal CLK2 periodically turns the transistor T6 on and off. Therefore, the gate-off voltage Voff is periodically applied to the junction J3. Accordingly, the junction J3 continuously sustains the gate-off voltage Voff. After the next carry signal [Cout(i+1)] transits to the low voltage and the transistor T3 is turned off, the junction J3 of an i^{th} stage [ST(i)] sustains the low voltage, for example, the gate-off voltage Voff, regardless of the first and second clock signals CLK1 and CLK2.

For example, when the first clock signal CLK1 is the high voltage and the second clock signal CLK2 is the low voltage, the voltage of the junction J2 rises by the capacitor C1 to turn on the transistors T4 and T5. Accordingly, the gate-off voltage Voff is transferred to the junction J1 to sustain the transistors T1 and T7 in a turned-off state. Further, the gate-off voltage Voff is transferred to the junction J3 through the turned-on transistor T5.

When the first clock signal CLK1 is the low voltage and the second clock signal CLK2 is the high voltage, the voltage of the junction J2 falls by the capacitor C1 to turn off the transistors T4 and T5. Accordingly, the junction J1 is floated. Therefore, the junction J1 sustains the low voltage, which is the previous voltage, by the capacitor C2 to sustain the transistors T1 and T7 in a turned-off state. Also, the transistor T6 is turned on, and the gate-off voltage Voff is transferred to the junction J3.

Although the first and second clock signals CLK1 and CLK2 change at later predetermined periods, the junction J3 constantly sustains the gate-off voltage Voff.

Since a path selection signal SEL 1 applied to a selection terminal SE1 is a high level voltage and a path selection signal SEL2 applied to a selection terminal SE2 is a low level voltage during an image display period PR1, the transistor T8 is turned on and the transistor T9 is turned off. Therefore, a gate-on/off voltage Von and Voff, which is gate output, is transferred from the junction J3 to an output terminal OUT1 and is not transferred to an output terminal OUT2. Finally, a scanning signal is applied to an image scanning line Gi for the image display period PR1.

Since a path selection signal SEL1 is a low level voltage and a path selection signal SEL2 is a high level voltage for a sensing period PR2, the transistor T8 is turned off and the transistor T9 is turned on. Therefore, a scanning signal is applied to a sensing scanning line Si. As described above, the image scanning signal is outputted to the first stage [ST1] to the last stage [ST(n)] for the image display period PR1, and a sensing scanning signal is outputted to the first stage [ST1] to the last stage [ST(n)] for the sensing period PR2.

Unlike the present exemplary embodiment, one selection signal and one selection terminal may be included. In this case, the gate driver 400 further includes an inverter between a selection terminal and a control terminal of one of two thin film transistors T8 and T9. Using the inverter, two signals having opposite phases can be applied to control terminals of two thin film transistors T8 and T9.

A carry output terminal COUT always outputs the voltage of the junction J3 regardless of the path selection signals SEL1 and SEL2.

As described above, the touch sensitive display device according to an exemplary embodiment of the present invention, a driving apparatus thereof, and a driving method thereof can drive pixels and sensors using one gate driver. Therefore, the structure of the display device can be simplified.

It is to be understood that the invention is not limited to the disclosed exemplary embodiments and is intended to cover various modifications and equivalent arrangements.

What is claimed is:

1. An apparatus for driving a display device including a plurality of stages connected with one another for sequentially generating output signals in synchronization with a plurality of clock signals, at least one of the plurality of stages comprising:
an input section for outputting a first voltage in response to an output signal from a previous stage or a scanning start signal;
a middle processing unit for outputting a second voltage in response to one of the plurality of clock signals or an output signal from a next stage;
an output voltage generator for charging the first voltage and generating an output signal in response to the first voltage from the input section and the second voltage from the middle processing unit; and
an output path selecting unit for selecting an output path for the output signal from the output voltage generator.

2. The apparatus of claim 1, wherein:
the first voltage is a high gate-on voltage Von; and
the second voltage is a low gate-off voltage Voff.

3. The apparatus of claim 1, wherein:
at least one of the plurality of stages has a first output terminal and a second output terminal; and
the output path selecting unit outputs the output signal through the output path by selecting the first output terminal or the second output terminal.

4. The apparatus of claim 3, wherein the output path selecting unit comprises:
a first transistor connected with the first output terminal; and
a second transistor connected with the second output terminal.

5. The apparatus of claim 4, wherein the first transistor and the second transistor operate opposite to each other.

6. The apparatus of claim 5, wherein first and second selection signals that are opposite in phase are applied to respective control terminals of the first and second transistors.

7. The apparatus of claim 4, wherein:
at least one of the plurality of stages further comprises a set terminal, a reset terminal, a gate voltage terminal, first and second clock terminals, and first and second selection terminals;
the input section comprises a third transistor that is connected between the set terminal and a first junction and has a control terminal connected with the set terminal;
the middle processing unit comprises
fourth and fifth transistors connected in parallel between the first junction and the gate voltage terminal,
a sixth transistor connected between a second junction and the gate voltage terminal, and
a first capacitor connected between the second junction and the first clock terminal,
wherein the fourth transistor has a control terminal connected with the reset terminal, the fifth transistor has a control terminal connected with the second junction, and the sixth transistor has a control terminal connected with the first junction;
the output voltage generator comprises
a seventh transistor connected between a third contract and the first clock terminal,
eighth and ninth transistors connected in parallel between the third junction and the gate voltage terminal, and
a second capacitor connected between the first junction and the third junction,
wherein the seventh transistor has a control terminal connected with the first junction, the eighth transistor has a control terminal connected with the second junction, and the ninth transistor has a control terminal connected with the second clock terminal; and
the first and second transistors are connected with the third junction.

8. The apparatus of claim 7, wherein a first selection signal is applied to the first selection terminal, and a second selection signal having a phase difference of 180° from the first selection signal is applied to the second selection terminal.

9. The apparatus of claim 3, wherein at least one of the plurality of stages further comprises a carry output terminal for outputting the output signal to previous and next stages.

10. A display device comprising:
a display panel assembly including a plurality of pixels having first switching elements, a plurality of image scanning lines connected with the first switching elements, a plurality of sensors having second switching elements, and a plurality of sensing scanning lines connected with the second switching elements; and
a gate driver connected with the image scanning lines and the sensing scanning lines for generating output signals and selectively applying the output signals to one of the image scanning lines and the sensing scanning lines.

11. The display device of claim 10, wherein
the gate driver comprises a plurality of stages connected with one another for generating output signals in turn in synchronization with a plurality of clock signals, and
at least one of the plurality of stages comprises:
an input section for outputting a first voltage in response to an output signal from a previous stage or a scanning start signal;
a middle processing unit for outputting a second voltage in response to one of the plurality of clock signals or an output signal from a next stage;
an output voltage generator for charging the first voltage and generating the output signal in response to the first voltage from the input section and the second voltage from the middle processing unit; and
an output path selecting unit for selecting an output path for the output signal from the output voltage generator.

12. The display device of claim 11, wherein the output path selecting unit comprises:
a first transistor connected with one of the image scanning lines; and
a second transistor connected with one of the sensing scanning lines, and
wherein the first transistor and the second transistor operate opposite to each other.

13. The display device of claim 12, wherein first and second selection signals that are opposite in phase are applied to respective control terminals of the first and second transistors.

14. The display device of claim 13, wherein:
at least one of the plurality of stages further comprises a set terminal, a reset terminal, a gate voltage terminal, first and second clock terminals, and first and second selection terminals;
the input section comprises a third transistor that is connected between the set terminal and a first junction and has a control terminal connected with the set terminal;
the middle processing unit comprises
fourth and fifth transistors connected in parallel between the first junction and the gate voltage terminal,
a sixth transistor connected between a second junction and the gate voltage terminal, and
a first capacitor connected between the second junction and the first clock terminal,
wherein the fourth transistor has a control terminal connected with the reset terminal, the fifth transistor has a control terminal connected with the second junction, and the sixth transistor has a control terminal connected with the first junction; and
the output voltage generator comprises
a seventh transistor connected between a third contract and the first clock terminal,
eighth and ninth transistors connected in parallel between the third junction and the gate voltage terminal, and
a second capacitor connected between the first junction and the third junction,
wherein the seventh transistor has a control terminal connected with the first junction, the eighth transistor has a control terminal connected with the second junction, and the ninth transistor has a control terminal connected with the second clock terminal.

15. The display device of claim 11, wherein at least one of the plurality of stages further comprises a carry output terminal for outputting the output signal to previous and next stages.

16. The display device of claim 14, wherein the first and second switching elements and the first to ninth transistors are made of amorphous silicon.

17. The display device of claim 16, wherein the gate driver is integrated with the display panel assembly.

18. A method for driving a display device comprising a plurality of pixels connected with image scanning lines and image data lines and a plurality of sensors connected with sensing scanning lines and sensing data lines, the method comprising:
applying a gate-on voltage to the image scanning lines in response to a first selection signal;
displaying an image through the pixels by applying an image data voltage to the image data lines;
applying a gate-on voltage to the sensing scanning lines in response to a second selection signal; and
performing a sensing operation by processing sensing data signals from the sensing data lines.

19. The method of claim 18, wherein the first and second selection signals in the applying of the gate-on voltages to the image scanning lines and the sensing scanning lines are opposite to each other in phase.

20. The method of claim 18, wherein the applying of the gate-on voltage to the image scanning lines and the displaying of the image alternate with the applying the gate-on voltage to the sensing scanning lines and the performing of the sensing operation.

21. The method of claim 18, wherein, after the applying of the gate-on voltage to the image scanning lines and the displaying of the image are performed for the pixels, the applying of the gate-on voltage to the sensing scanning lines and the performing of the sensing operation are performed for the sensors.

22. The method of claim 21, wherein, after the applying of the gate-on voltage to the image scanning lines and the displaying of the image are performed for the pixels more than twice successively, the applying of the gate-on voltage to the sensing scanning lines and the performing of the sensing operation are performed for the sensors.
